(19) United States
(12) Patent Application Publication
(10) Pub. No.: US 2023/0304121 A1
(43) Pub. Date: Sep. 28, 2023

(54) 980 MPA-GRADE ULTRA-LOW-CARBON MARTENSITE AND RETAINED AUSTENITE ULTRA-HIGH HOLE EXPANSION STEEL AND MANUFACTURING METHOD THEREFOR

(71) Applicant: BAOSHAN IRON & STEEL CO., LTD., Shanghai (CN)

(72) Inventors: Huanrong WANG, Shanghai (CN); Chen ZHANG, Shanghai (CN); Feng YANG, Shanghai (CN); Ana YANG, Shanghai (CN)

(73) Assignee: BAOSHAN IRON & STEEL CO., LTD., Shanghai (CN)

(21) Appl. No.: 18/043,116

(22) PCT Filed: Aug. 30, 2021
(86) PCT No.: PCT/CN2021/115426

§ 371 Date: Feb. 27, 2023

(30) Foreign Application Priority Data
Aug. 31, 2020 (CN) 202010896487.1

(51) Int. Cl. C21D 9/46; C22C 33/04; C22C 38/58; C22C 38/54; C22C 38/50; C22C 38/48; C22C 38/46; C22C 38/44; C22C 38/38; C22C 38/34; C22C 38/32; C22C 38/28; C22C 38/26; C22C 38/24; C22C 38/22; C22C 38/20; C22C 38/16; C22C 38/14; C22C 38/12; C22C 38/08; C22C 38/06; C22C 38/04; C22C 38/02; C22C 38/00; C21D 8/02; C21D 6/00; C21D 1/84

(52) U.S. Cl. CPC C21D 9/46; C22C 33/04; C22C 38/58; C22C 38/54; C22C 38/50; C22C 38/48; C22C 38/46; C22C 38/44; C22C 38/38; C22C 38/34; C22C 38/32; C22C 38/28; C22C 38/26; C22C 38/24; C22C 38/22; C22C 38/20; C22C 38/16; C22C 38/14; C22C 38/12; C22C 38/08; C22C 38/06; C22C 38/04; C22C 38/02; C22C 38/002; C22C 38/001; C21D 8/0205; C21D 8/0226; C21D 8/0263; C21D 8/0278; C21D 6/001; C21D 6/002; C21D 6/004; C21D 6/005; C21D 6/008; C21D 1/84; C21D 2211/008; C21D 2211/001

(57) ABSTRACT

A 980 MPa-grade ultra-low-carbon martensite and retained austenite ultra-high hole expansion steel and a manufacturing method therefor. The hole expansion steel comprises the following chemical components in percentage by weight: C 0.03%-0.06%, Si 0.8%-2.0%, Mn 1.0%-2.0%, P≤0.02%, S≤0.003%, Al 0.02%-0.08%, N≤0.004%, Mo 0.1%-0.5%, Ti 0.01%-0.05%, and O≤0.0030%. The high hole expansion steel of the present invention has the yield strength ≥800 MPa, the tensile strength ≥980 MPa, the elongation rate (horizontal A50≥10%), the cold bending property (d≤4a, 180°), and the hole expansion ratio ≥80%, and can be applied to a chassis part of a passenger vehicle such as a control arm, an auxiliary frame and other parts that require high-strength thinning.

### TECHNICAL FIELD

The present disclosure pertains to the field of high-strength steel, and in particular relates to a 980 MPa-grade ultra-low-carbon martensitic-retained austenitic ultra-high-hole-expandability steel, and a manufacturing method for the same.

### BACKGROUND ART

Along with the development of the national economy, the production of automobiles has increased significantly, and the consumption of plates has also continued to increase. In the domestic automobile industry, the use of hot-rolled or pickled plates is required by the early design of components and parts of many types of vehicles, such as chassis parts, torsion beams, car sub-frames, wheel spokes and rims, front and rear axle assemblies, body structural parts, seats, clutches, seat belts, truck box panels, protective nets, automotive beams and other spare parts. Chassis steel accounts for 24-34% of the total steel consumption of a car.

Weight reduction of passenger vehicles is not only a development trend in the automotive industry, but also a requirement of the laws and regulations. Fuel consumption per hundred kilometers is restricted by the laws and regulations. This is actually a disguised requirement to reduce the weight of the vehicle body, and in turn, the materials are required to have higher strength, smaller thickness and lower weight. Higher strength and lower weight will certainly be requirements of new model vehicles in the future. This will inevitably lead to use of steel of higher grades, and also change in chassis structure. For example, parts will be more complex. As such, improvements are necessary in the performances and surface quality of materials, as well as forming technologies, such as hydroforming, hot stamping, laser welding, etc. In turn, the strength, stamping performance, flanging performance, resilience, fatigue resistance and other performances of the materials need to be improved.

The high-strength and high-hole-expandability steel developed in China not only has relatively low strength compared with that developed in foreign countries, but also has poor performance stability. For example, the high-hole-expandability steel used by domestic auto parts companies is basically high-strength steel having a tensile strength of 600 MPa or less, and the competition in the market of high-hole-expandability steel of the 440 MPa grade or lower is red hot. Nowadays, the high-hole-expandability steel having a tensile strength of 780 MPa starts to be used gradually on a large scale. However, high requirements are also imposed on two important indicators in the forming process, namely elongation and hole expansion ratio. Unfortunately, 980 MPa-grade high-hole-expandability steel is still in the stage of R&D and validation, and has not yet reached the stage of mass use. However, the 980 MPa-grade high-hole-expandability steel having higher strength and higher hole expansion ratio is an inevitable development trend in the future. In order to better meet the potential needs of users in the future, it is necessary to develop a 980 MPa-grade high-hole-expandability steel having good hole expandability.

So far, most of the relevant patent documents are directed to high-hole-expandability steel of the 780 MPa grade and lower. There are very few literatures related to 980 MPa-grade high-hole-expandability steel. Chinese Patent Publication CN106119702A discloses a 980 MPa-grade hot-rolled high-hole-expandability steel. The main characteristic of the design of its composition is a low-carbon V-Ti microalloying design. Its microstructure is granular bainite and a small amount of martensite. At the same time, trace amounts of Nb and Cr are added.

As it can be seen from the literatures, the elongation of a material is generally inversely proportional to the hole expansion ratio. That is, the higher the elongation, the lower the hole expansion ratio; conversely, the lower the elongation, the higher the hole expansion ratio. Hence, it is very difficult to obtain a high-hole-expandability steel having high elongation and high hole expandability on the one hand, and high strength on the other hand.

In addition, under the same or similar strengthening mechanism, the higher the strength of the material, the lower the hole expansion ratio. In order to obtain a steel having both good plasticity and good hole expandability/flanging ability, a better balance between them is required. Of course, the hole expansion ratio of a material is closely related with many factors, among which the most important factors include the uniformity of the structure, the level at which inclusions and segregation are controlled, different structure types, the measurement of the hole expansion ratio, and the like. Generally speaking, a single uniform structure is beneficial to obtain a higher hole expansion ratio, while a dual-phase or multiphase structure is usually not beneficial to increase the hole expansion ratio.

### SUMMARY

One object of the present disclosure is to provide a 980 MPa-grade ultra-low-carbon martensitic-retained austenitic ultra-high-hole-expandability steel, and a manufacturing method for the same. The high-hole-expandability steel has a yield strength of ≥800 MPa, and a tensile strength of ≥980 MPa. The high-strength and high-hole-expandability steel can be used for some parts of a chassis of a passenger vehicle, such as a control arm and a sub-frame, which require higher strength and smaller thickness.

To achieve the above object, the technical solution of the present disclosure is as follows:

In the compositional design according to the present disclosure, a relatively low C content is employed to ensure that the steel has excellent weldability during use, and ensure that the low-carbon martensite structure obtained has good hole expandability and impact toughness. On the premise that the tensile strength of ≥980 MPa is satisfied, the carbon content should be as low as possible. A higher Si content is designed to cooperate with the process to obtain more retained austenite, thereby improving the plasticity of the material. At the same time, a higher Si content helps to reduce the sub-recrystallization temperature of the steel, so that the steel can accomplish the dynamic recrystallization process at a lower final rolling temperature, thereby refining the austenite grains and the final martensite grains, and improving the plasticity and hole expansion ratio.

Particularly, the 980 MPa-grade ultra-low-carbon martensitic-retained austenitic ultra-high-hole-expandability steel according to the present disclosure comprises the following chemical components in weight percentages: C 0.03%-0.06%, Si 0.8%-2.0%, Mn 1.0%-2.0%, P≤0.02%, S≤0.003%, Al 0.02-0.08%, N≤0.004%, Mo 0.1%-0.5%, Ti 0.01%-0.05%, O≤0.0030%, and a balance of Fe and other unavoidable impurities.

Further, the 980 MPa-grade ultra-low-carbon martensitic-retained austenitic ultra-high-hole-expandability according to the present disclosure further comprises one or more elements selected from the group consisting of Cr≤0.5%, B≤0.002%, Ca≤0.005%, Nb≤0.06%, V≤0.05%, Cu≤0.5%, Ni≤0.5%.

In some embodiments, the 980 MPa-grade ultra-low-carbon martensitic-retained austenitic ultra-high-hole-expandability steel according to the present disclosure comprises the following chemical components in weight percentages: C 0.03%-0.06%, Si 0.8%-2.0%, Mn 1.0%-2.0%, P≤0.02%, S≤0.003%, Al 0.02-0.08%, N≤0.004%, Mo 0.1%-0.5%, Ti 0.01%-0.05%, 020.0030%, Cr≤0.5%, B≤0.002%, Ca≤0.005%, Nb≤0.06%, V≤0.05%, Cu≤0.5%, Ni≤0.5%, and a balance of Fe and other unavoidable impurities; preferably, the ultra-low-carbon martensitic-retained austenitic ultra-high-hole-expandability steel comprises at least one of Cr, B, Ca, Nb, V, Cu and Ni, and preferably comprises at least Cr and/or B.

Cr preferably has a content of 0.2-0.4%; Cu and Ni each preferably have a content of ≤0.3%; Nb and V each preferably have a content of ≤0.03%; B preferably has a content of 0.0005-0.0015%; Ca preferably has a content of ≤0.002%.

Further, the 980 MPa-grade ultra-low-carbon martensitic-retained austenitic ultra-high-hole-expandability steel according to the present disclosure has a microstructure of bainite and a small amount of retained austenite. Preferably, the 980 MPa-grade ultra-low-carbon martensitic-retained austenitic ultra-high-hole-expandability steel comprises retained austenite in a proportion of ≤5% by volume.

Further, the 980 MPa-grade ultra-low-carbon martensitic-retained austenitic ultra-high-hole-expandability steel has a yield strength of ≥800 MPa, preferably ≥815 MPa, a tensile strength of ≥980 MPa, preferably ≥1000 MPa, more preferably ≥1030 MPa, a transverse A₅₀ of ≥10%, a hole expansion ratio of ≥80%, preferably ≥85%, more preferably ≥90%, and has passed cold bending test (d≤4a, 180°). Preferably, the 980 MPa-grade ultra-low-carbon martensitic-retained austenitic ultra-high-hole-expandability steel has an impact toughness at −40° C. of ≥140 J, preferably ≥150 J, more preferably ≥160 J.

Preferably, the 980 MPa-grade ultra-low-carbon martensitic-retained austenitic ultra-high-hole-expandability steel has a yield strength of ≥815 MPa, a tensile strength of ≥1000 MPa, a transverse A₅₀ of ≥10%, a hole expansion ratio of ≥85%, an impact toughness at −40° C. of ≥150 J, and has passed cold bending test (d≤4a, 180°).

Preferably, the 980 MPa-grade ultra-low-carbon martensitic-retained austenitic ultra-high-hole-expandability steel has a thickness of 2-6 mm.

In the compositional design of the 980 MPa-grade ultra-low-carbon martensitic-retained austenitic ultra-high-hole-expandability steel according to the present disclosure:

Carbon: Carbon is an essential element in the steel, and it's also one of the important elements in the present disclosure. Caron enlarges an austenite phase region and stabilizes austenite. As an interstitial atom in the steel, carbon plays an important role for increasing steel strength, and has the greatest influence on the yield strength and tensile strength of the steel. According to the present disclosure, the desired structure is low-carbon or ultra-low-carbon martensite. In order to obtain a high-strength steel having a tensile strength of the 980 MPa grade, it is necessary to ensure that the carbon content is 0.03% or higher. Otherwise, if the carbon content is below 0.03%, even if the steel is fully quenched to room temperature, the tensile strength still cannot reach 980 MPa. However, the carbon content should not be higher than 0.06%. If the carbon content is too high, the strength of the low-carbon martensite formed will be too high, and thus both the elongation and hole expansion ratio will be low. Therefore, the carbon content should be controlled at 0.03-0.06%, preferably at 0.04-0.055%.

Silicon: Silicon is an essential element in the steel, and it's also one of the important elements in present disclosure. In addition to increasing the solid solution strengthening effect, an increased Si content has the following two more important functions. The first important function is to reduce the sub-recrystallization temperature of the steel greatly, so that the steel can accomplish dynamic recrystallization at very low temperatures. As such, in the practical rolling process, rolling can be carried out at a relatively low final rolling temperature, such as rolling at a final rolling temperature in the range of 800-850° C. This can greatly reduce the grain size of austenite, thereby reducing the size of the final martensitic lath, which is not only conducive to improving the strength and plasticity, but also conducive to acquiring good hole expansion ratio. The second important role of Si is to inhibit precipitation of cementite. Under appropriate rolling process conditions, especially when a structure dominated by martensite is obtained, a certain amount of retained austenite may be left over. This is beneficial to increase the elongation. It's well known that martensite usually has the lowest elongation at the same strength level. In order to increase the elongation of martensite, one of the important measures is to keep a certain amount of stable retained austenite. This function of Si is manifested only when its content reaches 0.8% or higher. However, the content of Si should not be too high; otherwise, the rolling load will be too large in the practical rolling process, which is not conducive to stable production of products. Therefore, the Si content in the steel is generally controlled at 0.8-2.0%, preferably 1.2-1.6%.

Manganese: Manganese is the most essential element in the steel, and it's also one of the most important elements in the present disclosure. It's well known that Mn is an important element for enlarging the austenite phase region, and it can reduce the critical quenching rate of steel, stabilize austenite, refine grains, and delay transformation of austenite to pearlite. According to the present disclosure, in order to guarantee the strength of the steel plate and stabilize retained austenite as well, the Mn content is generally controlled at 1.0% or higher. At the same time, the Mn content should generally not exceed 2.0%; otherwise, Mn segregation will occur easily during steelmaking, and hot cracking is also prone to occur during continuous casting of the slab. Therefore, the content of Mn in the steel is generally controlled at 1.0-2.0%, preferably 1.4-1.8%.

Phosphorus: Phosphorus is an impurity element in the steel. P has a strong propensity to segregate to grain boundaries. When the P content in the steel is relatively high (≥0.1%), Fe₂P will form and precipitate around the grains, leading to decreased plasticity and toughness of the steel. Therefore, its content should be as low as possible. Generally, it's desirable to control its content within 0.02%, so that the steelmaking cost will not be increased.

Sulfur: Sulfur is an impurity element in the steel. S in the steel often combines with Mn to form MnS inclusions. Particularly, when the contents of both S and Mn are relatively high, a large amount of MnS will form in the steel. MnS has certain plasticity itself, and it will deform in the rolling direction in a subsequent rolling process, so that not only the transverse plasticity of the steel will be degraded, but also the anisotropy of the structure will be increased, which is unfavorable to the hole expandability. Therefore, the S content in the steel should be as low as possible. Considering that the Mn content in the present disclosure must be at a higher level, in order to reduce the MnS content, the S content should be strictly controlled. It's required to control the S content within 0.003%, preferably at 0.0015% or less.

Aluminum: The main role of aluminum in the steel is deoxygenation and nitrogen fixation. In the presence of strong carbide-forming elements such as Ti, Nb, V and the like, the main function of Al is deoxygenation and grain refinement. According to the present disclosure, the content of Al as a common element for deoxygenation and grain refinement is generally controlled at 0.02-0.08%. If the Al content is lower than 0.02%, it cannot achieve the grain refinement effect; if the Al content is higher than 0.08%, the grain refinement effect comes to a plateau. Therefore, the content of Al in the steel is controlled at 0.02-0.08%, preferably 0.02-0.05%.

Nitrogen: Nitrogen is an impurity element in the present disclosure, and its content should be as low as possible. However, nitrogen is an unavoidable element in the steelmaking process. Although its content is low, it can combine with strong carbide-forming elements such as Ti to form TiN particles which have a very adverse influence on the performances of the steel, especially unfavorable to the hole expandability. Due to the square shape of TiN, a large stress concentration exists between its sharp corner and the matrix. During the process of hole expansion deformation, the stress concentration between TiN and the matrix is prone to cause cracking which greatly reduces the hole expandability of the material. Provided that the nitrogen content is controlled at one's best, the contents of strong carbide-forming elements such as Ti should be as low as possible. According to the present disclosure, a trace amount of Ti is added to fix nitrogen, so as to minimize the adverse influence of TiN. Therefore, the nitrogen content should be controlled at 0.004% or lower, preferably 0.003% or lower.

Titanium: Titanium is one of the important elements in the present disclosure. Ti has primarily two functions in the present disclosure. One is to combine with the impurity element N in the steel to form TiN, so as to play a part in “nitrogen fixation”; and the other one is to form a certain amount of dispersed fine TiN in a subsequent process of welding the material, thereby suppressing the austenite grain size, refining the structure and improving the low temperature toughness. Therefore, the content of Ti in the steel is controlled at 0.01-0.05%, preferably in the range of 0.01-0.03%.

Molybdenum: Molybdenum is one of the important elements in the present disclosure. The addition of molybdenum to the steel can greatly delay the phase transformation of ferrite and pearlite. This effect of molybdenum allows for adjustment of various procedures in the practical rolling process. For example, after the final rolling is completed, staged cooling may be conducted, or air cooling and water cooling may be conducted in sequence. In the present disclosure, the process of air cooling and water cooling in sequence or direct water cooling after rolling is adopted. The addition of molybdenum can ensure that a structure of ferrite or pearlite will not be formed during the air cooling. At the same time, dynamic restoration of the deformed austenite can occur during the air cooling. This helps to improve the structure uniformity. In addition, molybdenum is highly resistant to welding softening. Since the main purpose of the present disclosure is to obtain a single structure of low-carbon martensite with a small amount of retained austenite, and low-carbon martensite tends to soften after welding, the addition of a certain amount of molybdenum can effectively reduce the degree of welding softening. Therefore, the molybdenum content should be controlled at 0.1-0.5%, preferably 0.15-0.35%.

Chromium: Chromium is an optional element in the present disclosure. The addition of a small amount of chromium is not aimed to improve the hardenability of the steel, but to combine with B, which is conducive to formation of an acicular ferrite structure in the welding heat affected zone after welding, thereby greatly improving the low temperature toughness of the welding heat affected zone. Because the steel according to the present disclosure is finally used for parts which are products such as passenger vehicle chassis, the low-temperature toughness of the welding heat affected zone is a very important indicator. In addition to ensuring that the strength of the welding heat affected zone cannot be reduced too much, the low-temperature toughness of the welding heat affected zone must also meet certain requirements. Additionally, chromium itself also exhibits some resistance to welding softening. Therefore, the amount of chromium added to the steel is generally ≤0.5%, preferably in the range of 0.2-0.4%.

Boron: Boron is an optional element in the present disclosure. The main function of boron in the steel is to inhibit formation of proeutectoid ferrite by segregating at the prior austenite grain boundaries. The addition of boron to the steel can also greatly improve the hardenability of the steel. However, according to the present disclosure, the main purpose of adding a trace amount of boron is not to improve the hardenability, but to combine with chromium to improve the structure of the welding heat affected zone, and obtain an acicular ferrite structure having good toughness. The addition of element boron to the steel is generally controlled in an amount of 0.002% or lower, preferably in the range of 0.0005-0.0015%.

Calcium: Calcium is an optional element in the present disclosure. Calcium can improve the shape of sulfides such as MnS. For example, the long strip-shaped MnS and other sulfides are converted to spherical CaS. This helps to improve the shape of inclusions, thereby reducing the adverse influence of long strip-shaped sulfides on hole expandability. However, the addition of calcium in an excessive amount will increase the amount of calcium oxide which is unfavorable for hole expandability. Therefore, the amount of calcium added to the steel is generally ≤0.005%, preferably ≤0.002%.

Oxygen: Oxygen is an unavoidable element in steel making. For the present disclosure, the O content in the steel is generally 30 ppm or lower after deoxygenation, and thus there will be no obvious adverse influence on the performances of the steel plate. Therefore, the content of O in the steel may be controlled within 30 ppm.

Niobium: Niobium is one of the optional elements in the present disclosure. Like titanium, niobium is a strong carbide-forming element in the steel. The addition of niobium to the steel can greatly increase the sub-recrystallization temperature of the steel, help to obtain deformed austenite having a higher dislocation density in the finishing rolling stage, and refine the final phase transformation structure in the subsequent transformation process. However, the addition of too much niobium is undesirable. On the one hand, if the amount of niobium added exceeds 0.06%, it is easy to form relatively coarse niobium carbonitrides in the structure, which consumes some carbon atoms and thus reduces the precipitation strengthening effect of carbides. On the other hand, a high content of niobium further tends to cause anisotropy of the hot-rolled austenite structure. This anisotropy will be passed down to the final structure during the subsequent cooling phase transformation process, which is unfavorable for hole expandability. Therefore, the niobium content in the steel is generally controlled at ≤0.06%, preferably ≤0.03%.

Vanadium: Vanadium is an optional element in the present disclosure. Like titanium and niobium, vanadium is also a strong carbide-forming element. However, the solid solution or precipitation temperature of vanadium carbides is low, and they are usually all dissolved in austenite at the finishing rolling stage. Vanadium carbides begin to form in ferrite only when the temperature is decreased and phase transformation begins. Since the solid solubility of vanadium carbides in ferrite is greater than those of niobium and titanium carbides, vanadium carbides formed in ferrite have a larger size which is not conducive to precipitation strengthening. Hence, vanadium carbides contribute far less to the steel strength than titanium. In addition, the formation of vanadium carbides also consumes a certain amount of carbon atoms. This is unfavorable for improving the steel strength. Therefore, the amount of vanadium added to the steel is generally ≤0.05%, preferably ≤0.03%.

Copper: Copper is an optional element in the present disclosure. The addition of copper to the steel can improve the corrosion resistance of the steel. When it is added together with element P, the effect of corrosion resistance is better. When Cu is added in an amount of greater than 1%, an c-Cu precipitate phase may form under certain conditions. This precipitate phase has a relatively strong precipitation strengthening effect. However, the addition of Cu tends to cause the phenomenon of “Cu embrittlement” in the rolling process. In order to make full use of the effect of copper in improving corrosion resistance without causing obvious phenomenon of “Cu embrittlement” in some application scenarios, the content of element Cu is generally controlled within 0.5%, preferably within 0.3%.

Nickel: Nickel is an optional element in the present disclosure. The addition of nickel to the steel imparts certain corrosion resistance, but the effect of corrosion resistance is weaker than that of copper. The addition of nickel to the steel has little influence on the tensile performance of the steel, but it can refine the structure and precipitate phase of the steel, thereby greatly improving the low temperature toughness of the steel. At the same time, the addition of a small amount of nickel to the steel with copper added can inhibit the occurrence of “Cu embrittlement”. The addition of a relatively higher amount of nickel has no obvious adverse influence on the performances of the steel itself. Concurrent addition of copper and nickel can not only improve the corrosion resistance, but also refine the structure and precipitate phase of the steel, thereby greatly improving the low temperature toughness. However, because copper and nickel are relatively expensive alloying elements, in order to minimize the cost of alloy elements, the amount of nickel added is generally ≤0.5%, preferably ≤0.3%.

The method for manufacturing the 980 MPa-grade ultra-low-carbon martensitic-retained austenitic ultra-high-hole-expandability steel according to the present disclosure comprises the following steps:
1) Smelting, casting
wherein the above components are subjected to smelting in a converter or electrical furnace, secondary refining in a vacuum furnace, and casting to form a cast blank or ingot;
2) Reheating of the cast blank or ingot, wherein a heating temperature is 1100-1200° C.; and a holding time is 1-2 hours;
3) Hot rolling
wherein an initial rolling temperature is 950-1100° C.; wherein 3-5 passes of heavy reduction rolling is performed at a temperature of 950° C. or higher with an accumulated deformation rate of ≥50%, preferably ≥60%, to obtain an intermediate blank; wherein the intermediate blank is held till 900-950° C., preferably 920-950° C., and then subjected to final 3-5 passes of rolling with an accumulated deformation rate of ≥70%, preferably ≥85%, wherein a final rolling temperature is 800-920° C.;
4) Cooling
wherein air cooling is performed for 0-10 s first, and then the strip steel is water cooled at a cooling rate of ≥50° C./s, preferably 50-85° C./s, to a martensite start temperature Ms or a lower temperature, and then coiled and cooled to room temperature preferably at a cooling rate of ≤20° C./h;
5) Pickling
wherein a moving speed of the strip steel is adjusted within a range of 30-100 m/min during pickling; a pickling temperature is controlled at 75-85° C., and a tension leveling rate is controlled at ≤2% to reduce elongation loss of the strip steel; wherein the strip steel is then subjected to rinsing, surface drying, and oiling.

Preferably, in step 5), after the pickling, the rinsing is carried out at a temperature in a range of 35-50° C., and the surface of the strip steel is dried at 120-140° C., followed by oiling.

The innovative points of the present disclosure include:

In terms of the compositional design according to the present disclosure, the design concept is based on low-carbon or ultra-low-carbon martensite and the addition of a relatively high amount of silicon to suppress and reduce formation of cementite. At the same time, the addition of a relatively high amount of silicon can also help to decrease the sub-recrystallization temperature, so that the deformed austenite can accomplish the dynamic recrystallization process during the conventional finishing rolling in the austenite region. This is conducive to obtaining austenite grains having less difference between transverse and longitudinal performances. Therefore, in the subsequent cooling transformation process, a uniform structure of martensite and retained austenite is obtained. The relatively high content of manganese in the designed composition can stabilize austenite, while molybdenum significantly delays phase transformation of ferrite and pearlite. Martensite endows the steel plate with high strength; retained austenite endows the steel plate with relatively high plasticity and cold bending performance; and the uniform and fine structure endows the steel plate with higher hole expandability and excellent low-temperature impact toughness.

In terms of the design of the rolling process, at the rough rolling stage and the finishing rolling stage, the rolling procedure shall be completed as quickly as possible. After the final rolling is completed, air cooling is carried out for a certain period of time first. The main purpose of air cooling is explained as follows: the designed composition comprises relatively high contents of manganese and molybdenum. Manganese is an element that stabilizes austenite, while molybdenum significantly delays phase transformation of ferrite and pearlite. Therefore, during the air cooling for a certain period of time, the deformed austenite in the rolled steel will not undergo phase transformation. That is, no ferrite structure will be formed. Instead, dynamic recrystallization and relaxation will occur. The dynamic recrystallization of the deformed austenite allows for formation of quasi-equiaxed austenite having a uniform structure, and the dislocations in the relaxed austenite grains will be reduced notably. The combination of these two aspects enables obtainment of martensite having a uniform structure in the subsequent water hardening process. In order to obtain the martensite structure, the water cooling rate should be greater than the critical cooling rate of low-carbon martensite. In the present disclosure, the critical cooling rate of martensite is 30-50° C./s, depending on the composition and process. In order to ensure that all compositions in conformity with the design can provide martensite, the rate for water cooling the strip steel is required to be ≥50° C./s.

Since the microstructure involved in the present disclosure is low-carbon or ultra-low-carbon martensite, after the final rolling is completed, the steel strip only needs to be cooled to the martensite start temperature Ms or a lower temperature at a cooling rate greater than the critical cooling rate. The content of retained austenite at room temperature varies as a function of the cooling stop temperature. Generally, there is an optimal range of quenching stop temperature, which varies as a function of the alloy composition, generally in the range of 150-350° C. In order to obtain a high-strength steel having both good plasticity and hole expansion ratio, it is necessary to quench the strip steel to a temperature that is not higher than the Ms point. According to theoretical calculations and as verified by practical tests, when the strip steel is quenched to a temperature ≤Ms, a structure having excellent comprehensive performances can be obtained. If the quenching temperature is ≥Ms, although the amount of retained austenite is large, bainite will appear in the structure, so that the required strength of 980 MPa or higher cannot be achieved. For the above reasons, the coiling temperature needs to be controlled at ≤Ms. It is based on this innovative concept in the design of the composition and process that the 980 MPa-grade ultra-high-hole-expandability steel having excellent strength, plasticity, toughness, cold bending performance and hole expandability according to the present disclosure is obtained.

The beneficial effects of the present disclosure include:

A 980 MPa-grade high-hole-expandability steel having excellent strength, plasticity, toughness, cold bending performance and hole expandability can be obtained by adopting the design concept of a relatively economical composition and adopting the innovative cooling process according to the present disclosure.

The 980 MPa-grade steel coil or steel plate according to the present disclosure exhibits excellent matching of strength, plasticity, and toughness, and also has good cold bending performance and hole expandability/flanging ability. It has a yield strength of ≥800 MPa, and a tensile strength of ≥980 MPa. The hot-rolled or pickled high-hole-expandability steel having a thickness of 2-6 mm has good elongation (transverse A₅₀≥10%) and hole expandability (hole expansion ratio ≥80%) at the same time, and it has passed cold bending test (d≤4a, 180°), useful for manufacturing parts such as automobile chassis, sub-frames and the like that require high strength, reduced thickness, hole expansion and flanging, and has a very broad application prospect.

### BRIEF DESCRIPTION OF THE DRAWINGS

FIG. 1 is a process flow chart of the method for manufacturing a 980 MPa-grade ultra-low-carbon martensitic-retained austenitic ultra-high-hole-expandability steel according to the present disclosure;

FIG. 2 is a schematic view showing the rolling process in the method for manufacturing a 980 MPa-grade ultra-low-carbon martensitic-retained austenitic ultra-high-hole-expandability steel according to the present disclosure;

FIG. 3 is a schematic view showing the cooling process in the method for manufacturing a 980 MPa-grade ultra-low-carbon martensitic-retained austenitic ultra-high-hole-expandability steel according to the present disclosure.

### DETAILED DESCRIPTION

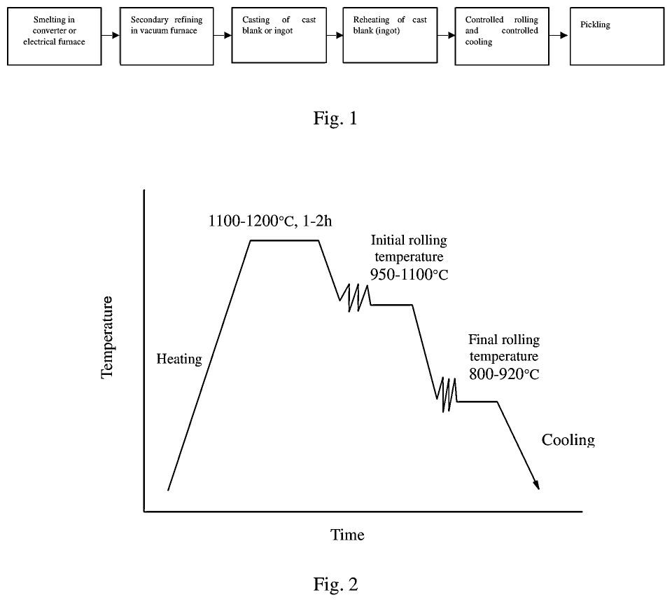

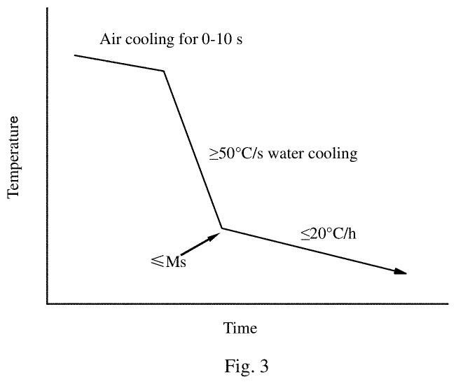

Referring to FIG. 1-FIG. 3, the method for manufacturing the 980 MPa-grade ultra-low-carbon martensitic-retained austenitic ultra-high-hole-expandability steel according to the present disclosure comprises the following steps:
1) Smelting, casting
wherein the above components are subjected to smelting in a converter or electrical furnace, secondary refining in a vacuum furnace, and casting to form a cast blank or ingot;
2) Reheating of the cast blank or ingot, wherein a heating temperature is 1100-1200° C.; and a holding time is 1-2 hours;
3) Hot rolling
wherein an initial rolling temperature is 950-1100° C.; wherein 3-5 passes of heavy reduction rolling is performed at a temperature of 950° C. or higher with an accumulated deformation rate of ≥50% to obtain an intermediate blank; wherein the intermediate blank is held till 900-950° C., and then subjected to final 3-5 passes of rolling with an accumulated deformation rate of ≥70%, wherein a final rolling temperature is 800-920° C.;
4) Cooling
wherein air cooling is performed for 0-10 s first, and then the strip steel is water cooled at a cooling rate of ≥50° C./s to a martensite start temperature Ms or a lower temperature, and then coiled and cooled (cooling rate ≤20° C./h) to room temperature;
5) Pickling
wherein a moving speed of the strip steel is adjusted within a range of 30-100 m/min during pickling; a pickling temperature is controlled at 75-85° C., and a tension leveling rate is controlled at ≤2%; wherein the strip steel is then subjected to rinsing at a temperature in a range of 35-50° C., surface drying at a temperature in a range of 120-140° C., and oiling.

The compositions of the Examples of the high-hole-expandability steel according to the present disclosure are shown in Table 1. The production process parameters for the Examples of the steel according to the present disclosure are listed in Table 2 and Table 3, wherein the thickness of the steel blank in the rolling process is 120 mm. The mechanical performances of the Examples of the steel plates according to the present disclosure are listed in Table 4. The tensile performances (yield strength, tensile strength, elongation) were tested in accordance with International Standard ISO6892-2-2018; the hole expansion ratio was tested in accordance with International Standard ISO16630-2017; and the impact toughness at −40° C. was tested in accordance with International Standard ISO14556-2015. The bending performance was tested in accordance with International Standard ISO7438-2005.

As it can be seen from Table 4, the yield strength of the steel coil is ≥800 MPa, while the tensile strength is ≥980 MPa, and the elongation is usually in the range of 10-13%. The impact energy is relatively stable. The low-temperature impact energy at −40° C. is stabilized in the range of 140-180 J. The content of retained austenite varies as a function of the coiling temperature, generally by 2-5%. The hole expansion ratio satisfies ≥80%.

As it can be seen from the above Examples, the 980 MPa high-strength steel according to the present disclosure exhibits good matching of strength, plasticity, toughness and hole expandability. It is especially suitable for parts that require high strength, reduced thickness, hole expansion and flanging forming, such as a control arm in an automobile chassis structure. It can also be used for parts such as wheels that need hole-flanging. Therefore, it has broad application prospects.

TABLE 1
(unit: weight %)

| Ex. | C | Si | Mn | P | S | Al | N | Mo | Ti | Cr | B | Ca | Nb | V | Cu | Ni | O |
|---|---|---|---|---|---|---|---|---|---|---|---|---|---|---|---|---|---|
| 1 | 0.060 | 1.98 | 1.76 | 0.0011 | 0.0028 | 0.066 | 0.0030 | 0.10 | 0.029 | 0.23 | 0.0011 | / | 0.030 | / | / | 0.40 | 0.0027 |
| 2 | 0.030 | 1.77 | 1.59 | 0.0013 | 0.0029 | 0.047 | 0.0027 | 0.17 | 0.025 | 0.35 | / | 0.001 | / | 0.015 | / | / | 0.0020 |
| 3 | 0.048 | 0.80 | 1.68 | 0.0016 | 0.0010 | 0.020 | 0.0028 | 0.49 | 0.050 | 0.50 | 0.0009 | / | 0.015 | / | / | 0.50 | 0.0025 |
| 4 | 0.055 | 1.26 | 1.99 | 0.0014 | 0.0024 | 0.039 | 0.0029 | 0.29 | 0.014 | 0.30 | 0.0010 | 0.002 | | / | 0.50 | / | 0.0029 |
| 5 | 0.042 | 1.18 | 1.88 | 0.0010 | 0.0028 | 0.065 | 0.0038 | 0.38 | 0.028 | 0.28 | 0.0012 | / | 0.060 | 0.010 | / | / | 0.0024 |
| 6 | 0.057 | 1.89 | 1.02 | 0.0015 | 0.0022 | 0.054 | 0.0033 | 0.33 | 0.015 | 0.10 | 0.0013 | 0.005 | / | 0.030 | / | 0.10 | 0.0028 |
| 7 | 0.053 | 1.53 | 1.96 | 0.0014 | 0.0017 | 0.079 | 0.0035 | 0.43 | 0.010 | 0.33 | 0.0020 | / | / | / | 0.15 | / | 0.0021 |
| 8 | 0.041 | 1.64 | 1.73 | 0.0012 | 0.0025 | 0.036 | 0.0022 | 0.18 | 0.020 | / | 0.0019 | 0.003 | / | 0.050 | 0.30 | 0.30 | 0.0030 |

TABLE 2

| | | | | Accumulated | | Accumulated | | | | | |
|---|---|---|---|---|---|---|---|---|---|---|---|
| | | | Initial | deformation | Intermediate | deformation | Final | | Water | Steel | |
| | Heating | Holding | rolling | rate during | blank | rate during | rolling | Air | cooling | plate | Coiling |
| | temperature | time | temperature | rough rolling | temperature | finishing | temperature | cooling | rate | thickness | temperature |
| | ° C. | h | ° C. | % | ° C. | rolling % | ° C. | times | ° C./s | mm | ° C. |
| Ex. 1 | 1170 | 1.3 | 1040 | 70 | 950 | 89 | 880 | 5 | 60 | 6 | 390 |
| Ex. 2 | 1160 | 1.4 | 1090 | 50 | 900 | 92 | 820 | 9 | 50 | 5 | 125 |
| Ex. 3 | 1190 | 1.0 | 1100 | 65 | 930 | 90 | 900 | 4 | 55 | 3 | 280 |
| Ex. 4 | 1130 | 1.7 | 960 | 55 | 910 | 94 | 820 | 7 | 70 | 4 | 250 |
| Ex. 5 | 1150 | 1.5 | 1020 | 60 | 940 | 88 | 850 | 10 | 65 | 4 | r.t. |
| Ex. 6 | 1120 | 2.0 | 1000 | 75 | 920 | 93 | 810 | 6 | 80 | 2 | 180 |
| Ex. 7 | 1140 | 1.8 | 980 | 80 | 930 | 90 | 920 | 0 | 75 | 3 | 230 |
| Ex. 8 | 1180 | 1.2 | 1050 | 70 | 925 | 91 | 830 | 8 | 85 | 2 | 150 |

TABLE 3

| | Moving | | | | |
|---|---|---|---|---|---|
| | speed | | | | |
| | of strip | | | | |
| | steel during | Pickling | Tension | Rinsing | Drying |
| | pickling | temperature | leveling | temperature | temperature |
| | m/min | ° C. | rate % | ° C. | ° C. |
| Ex. 1 | 90 | 76 | 1.2 | 40 | 128 |
| Ex. 2 | 45 | 83 | 2.0 | 35 | 140 |
| Ex. 3 | 60 | 75 | 0.6 | 48 | 133 |
| Ex. 4 | 100 | 79 | 1.4 | 36 | 130 |
| Ex. 5 | 40 | 82 | 1.8 | 45 | 125 |
| Ex. 6 | 50 | 85 | 0.8 | 50 | 136 |
| Ex. 7 | 30 | 78 | 1.6 | 42 | 120 |
| Ex. 8 | 80 | 80 | 0.4 | 38 | 132 |

TABLE 4
Mechanical performances of steel plates

| | | | | Hole | −40° C. | Retained |
|---|---|---|---|---|---|---|
| | Yield | Tensile | | expansion | impact | austenite |
| | strength | strength | Elongation | ratio | energy | content |
| | MPa | MPa | % | % | J | % |
| Ex. 1 | 809 | 1002 | 11.5 | 106.5 | 168 | 1.86 |
| Ex. 2 | 821 | 1034 | 12.5 | 90.9 | 170 | 2.49 |
| Ex. 3 | 806 | 1104 | 11.0 | 95.1 | 154 | 4.58 |
| Ex. 4 | 850 | 1011 | 10.5 | 82.8 | 144 | 2.64 |
| Ex. 5 | 819 | 1033 | 11.0 | 86.9 | 158 | 0.66 |
| Ex. 6 | 820 | 1032 | 12.0 | 87.2 | 182 | 4.33 |
| Ex. 7 | 883 | 1039 | 11.0 | 83.5 | 162 | 4.02 |
| Ex. 8 | 866 | 1050 | 10.5 | 100.7 | 180 | 3.56 |

Note:
The impact energy is obtained by converting the measured impact energy of a sample having an actual thickness into the impact energy of a standard sample of 10*10*55 mm in proportion based on equivalent effect.

1. A 980 MPa-grade ultra-low-carbon martensitic-retained austenitic ultra-high-hole-expandability steel, comprising the following chemical components in weight percentages: C 0.03%-0.06%, Si 0.8%-2.0%, Mn 1.0%-2.0%, P≤0.02%, S≤0.003%, Al 0.02-0.08%, N≤0.004%, Mo 0.1%-0.5%, Ti 0.01%-0.05%, O≤0.0030%, and a balance of Fe and other unavoidable impurities.

2. The 980 MPa-grade ultra-low-carbon martensitic retained austenitic ultra-high-hole-expandability steel according to claim 1, further comprising one or more elements selected from the group consisting of Cr≤0.5%, B≤0.002%, Ca≤0.005%, Nb≤0.06%, V≤0.05%, Cu≤0.5%, and Ni≤0.5%.

3. The 980 MPa-grade ultra-low-carbon martensitic-retained austenitic ultra-high-hole-expandability steel according to claim 1, comprising the following chemical components in weight percentages: C 0.03%-0.06%, Si 0.8%-2.0%, Mn 1.0%-2.0%, P≤0.02%, S≤0.003%, Al 0.02-0.08%, N≤0.004%, Mo 0.1%-0.5%, Ti 0.01%-0.05%, O≤0.0030%, Cr≤0.5%, B≤0.002%, Ca≤0.005%, Nb≤0.06%, V≤0.05%, Cu≤0.5%, Ni≤0.5%, and comprising at least one of Cr, B, Ca, Nb, V, Cu and Ni, or comprising at least Cr and/or B, and a balance of Fe and other unavoidable impurities.

4. The 980 MPa-grade ultra-low-carbon martensitic-retained austenitic ultra-high-hole-expandability steel according to claim 1, wherein C: 0.04-0.055%.

5. The 980 MPa-grade ultra-low-carbon martensitic-retained austenitic ultra-high-hole-expandability steel according to claim 1, wherein Si: 1.2-1.6%.

6. The 980 MPa-grade ultra-low-carbon martensitic-retained austenitic ultra-high-hole-expandability steel according to claim 1, wherein Mn: 1.4-1.8%.

7. The 980 MPa-grade ultra-low-carbon martensitic-retained austenitic ultra-high-hole-expandability steel according to claim 1, wherein S is controlled to have a content of 0.0015% or lower, and/or N is controlled to have a content of 0.003% or lower.

8. The 980 MPa-grade ultra-low-carbon martensitic-retained austenitic ultra-high-hole-expandability steel according to claim 1, wherein Al: 0.02-0.05%.

9. The 980 MPa-grade ultra-low-carbon martensitic-retained austenitic ultra-high-hole-expandability steel according to claim 1, wherein Ti: 0.01-0.03%, and/or Mo: 0.15-0.35%.

10. The 980 MPa-grade ultra-low-carbon martensitic-retained austenitic ultra-high-hole-expandability steel according to claim 1, wherein the ultra-high-hole-expandability steel has a microstructure of bainite and a small amount of retained austenite.

11. The 980 MPa-grade ultra-low-carbon martensitic-retained austenitic ultra-high-hole-expandability steel according to claim 1, wherein the ultra-high-hole-expandability steel has a yield strength of ≥800 MPa, a tensile strength of ≥980 MPa, a transverse A₅₀ of ≥10%, a hole expansion ratio of ≥80%, and has passed cold bending test (d≤4a, 180°).

12. The 980 MPa-grade ultra-low-carbon martensitic-retained austenitic ultra-high-hole-expandability steel according to claim 1, wherein the ultra-high-hole-expandability steel has an impact toughness at −40° C. of ≥140 J.

13. The 980 MPa-grade ultra-low-carbon martensitic-retained austenitic ultra-high-hole-expandability steel according to claim 1, wherein the ultra-high-hole-expandability steel has a yield strength of ≥815 MPa, a tensile strength of ≥1000 MPa, a transverse A₅₀ of ≥10%, a hole expansion ratio of ≥85%, an impact toughness at −40° C. of ≥150 J, and has passed cold bending test (d≤4a, 180°).

14. A method for manufacturing the 980 MPa-grade ultra-low-carbon martensitic-retained austenitic ultra-high-hole-expandability steel according to claim 1, comprising the following steps:
1) Smelting, casting
wherein the components according to claim 1 are subjected to smelting in a converter or electrical furnace, secondary refining in a vacuum furnace, and casting to form a cast blank or ingot;
2) Reheating of the cast blank or ingot, wherein a heating temperature is 1100-1200° C.; and a holding time is 1-2 hours;
3) Hot rolling
wherein an initial rolling temperature is 950-1100° C.; wherein 3-5 passes of heavy reduction rolling is performed at a temperature of 950° C. or higher with an accumulated deformation rate of ≥50%, to obtain an intermediate blank; wherein the intermediate blank is held till 900-950° C., and then subjected to final 3-5 passes of rolling with an accumulated deformation rate of ≥70%, wherein a final rolling temperature is 800-920° C.;
4) Cooling
wherein air cooling is performed for 0-10 s first, and then the strip steel is water cooled at a cooling rate of ≥50° C./s, to a martensite start temperature Ms or a lower temperature, and then coiled and cooled to room temperature;
5) Pickling
wherein a moving speed of the strip steel is adjusted within a range of 30-100 m/min during pickling; a pickling temperature is controlled at 75-85° C., and a tension leveling rate is controlled at ≤2%; wherein the strip steel is then subjected to rinsing, surface drying, and oiling.

15. The method for manufacturing the 980 MPa-grade ultra-low-carbon martensitic-retained austenitic ultra-high hole-expandability steel according to claim 14, wherein in step 5), after the pickling, the rinsing is carried out at a temperature in a range of 35-50° C., and the surface of the strip steel is dried at 120-140° C., followed by oiling.

16. The 980 MPa-grade ultra-low-carbon martensitic-retained austenitic ultra-high-hole-expandability steel according to claim 2, wherein Cr has a content of 0.2-0.4%; Cu and Ni each have a content of ≤0.3%; Nb and V each have a content of ≤0.03%; B has a content of 0.0005-0.0015%; and Ca has a content of ≤0.002%.

17. The method for manufacturing the 980 MPa-grade ultra-low-carbon martensitic-retained austenitic ultra-high hole-expandability according to claim 14, wherein:
the 980 MPa-grade ultra-low-carbon martensitic-retained austenitic ultra-high-hole-expandability steel further comprises one or more elements selected from Cr≤0.5%, B≤0.002%, Ca≤0.005%, Nb≤0.06%, V0.05%, Cu≤0.5%, and Ni≤0.5%; or
the 980 MPa-grade ultra-low-carbon martensitic-retained austenitic ultra-high-hole-expandability steel comprises the following chemical components in weight percentages: C 0.03%-0.06%, Si 0.8%-2.0%, Mn 1.0%-2.0%, P≤0.02%, S0.003%, Al 0.02-0.08%, N≤0.004%, Mo 0.1%-0.5%, Ti 0.01%-0.05%, O≤0.0030%, Cr≤0.5%, B≤0.002%, Ca≤0.005%, Nb≤0.06%, V0.05%, Cu≤0.5%, Ni≤0.5%, and comprises at least one of Cr, B, Ca, Nb, V, Cu and Ni, or comprises at least Cr and/or B, and a balance of Fe and other unavoidable impurities.

18. The method for manufacturing the 980 MPa-grade ultra-low-carbon martensitic-retained austenitic ultra-high hole-expandability according to claim 14, wherein the 980 MPa-grade ultra-low-carbon martensitic-retained austenitic ultra-high-hole-expandability steel comprises: C: 0.04-0.055%, Si: 1.2-1.6%, Mn: 1.4-1.8%, S: 0.0015% or lower and/or N: 0.003% or lower, Al: 0.02-0.05%, Ti: 0.01-0.03% and/or Mo: 0.15-0.35%; or the 980 MPa-grade ultra-high-hole-expandability steel has a microstructure of bainite and a small amount of retained austenite.

19. The method for manufacturing the 980 MPa-grade ultra-low-carbon martensitic-retained austenitic ultra-high hole-expandability according to claim 14, wherein the 980 MPa-grade ultra-low-carbon martensitic-retained austenitic ultra-high-hole-expandability steel has a yield strength of ≥300 MPa, a tensile strength of ≥980 MPa, a transverse A₅₀ of ≥10%, a hole expansion ratio of ≥80%, and has passed cold bending test (d≤4a, 180°).

20. The method for manufacturing the 980 MPa-grade ultra-low-carbon martensitic-retained austenitic ultra-high hole-expandability according to claim 14, wherein:
in step 3), 3-5 passes of heavy reduction rolling is performed at a temperature of 950° C. or higher with an accumulated deformation rate of ≥60% to obtain an intermediate blank; the intermediate blank is subjected to final 3-5 passes of rolling with an accumulated deformation rate of ≥85%;
in step 4), the cooling rate is 50-85° C./s.
